(19) United States
(12) Patent Application Publication
(10) Pub. No.: US 2023/0219440 A1
(43) Pub. Date: Jul. 13, 2023

(54) CHARGING TRAILER AND METHOD

(71) Applicant: Ford Global Technologies, LLC, Dearborn, MI (US)

(72) Inventors: Stuart C. Salter, White Lake, MI (US); Lorne Forsythe, Novi, MI (US); Hussein H. Berry, Dearborn, MI (US); Todd Ansbacher, Westland, MI (US); Pietro Buttolo, Dearborn Heights, MI (US)

(73) Assignee: Ford Global Technologies, LLC, Dearborn, MI (US)

(21) Appl. No.: 17/574,709

(22) Filed: Jan. 13, 2022

(51) Int. Cl. B60L 53/50; B60L 53/62; B60L 53/66; B60L 53/10; B60W 20/20

(52) U.S. Cl. CPC B60L 53/50; B60L 53/62; B60L 53/66; B60L 53/10; B60W 20/20; B60W 2420/52; B60W 2420/42

(57) ABSTRACT

A charging trailer is provided and includes one or more motors to maneuver the charging trailer, a rechargeable battery pack for storing electrical energy, a recharging port for receiving electrical power from a charger to recharge the rechargeable battery pack, and one or more charging ports for charging one or more pieces of electrically powered equipment with the electrical energy stored in the rechargeable battery pack. The charging trailer also includes a controller for controlling movement of the charging trailer to position the charging trailer in a use position to charge the one or more pieces of electrically powered equipment.

### FIELD OF THE DISCLOSURE

The present disclosure generally relates to mobile charging and, more particularly relates to a charging vehicle, such as a charging trailer for providing electrical charging.

### BACKGROUND OF THE DISCLOSURE

Charging trailers provide transportable battery packs for charging electrical devices, such as electric vehicles and equipment. Electrically powered charging trailers may be employed on a construction site to charge various pieces of electrically powered equipment. It may be desirable to provide for a charging trailer that offers enhanced charging capability, particularly for use at a construction site.

### SUMMARY OF THE DISCLOSURE

According to a first aspect of the present disclosure, a charging vehicle is provided. The charging vehicle includes one or more motors to maneuver the charging vehicle, a rechargeable battery pack for storing electrical energy, a recharging port for receiving electrical power from a charger to recharge the rechargeable battery pack, one or more charging ports for charging one or more batteries associated with electrically powered equipment with the electrical energy stored in the rechargeable battery pack, and a controller for controlling movement of the charging vehicle to position the charging vehicle in a use position to charge the one or more batteries associated with the electrically powered equipment.

Embodiments of the first aspect of the disclosure can include any one or a combination of the following features:
the charging vehicle is configured as a charging trailer;
a plurality of sensors for sensing terrain and location of the electrically powered equipment, wherein the controller generates a control signal to maneuver the vehicle based on outputs received from the plurality of sensors;
the plurality of sensors comprises one or more cameras;
the plurality of sensors further comprises one or more radar sensors;
the charge vehicle further comprises one or more robot arms for connecting one or more charging cables to the one or more charging ports;
the controller controls movement of a canopy or the charging vehicle from a first position to a second position based on sun exposure;
a plurality of wheels; and
the charging vehicle is maneuvered about a construction site.

According to a second aspect of the present disclosure, a charging trailer is provided. The charging trailer includes a plurality of wheel assemblies, one or more motors operatively coupled to the plurality of wheel assemblies to maneuver the charging trailer, and a rechargeable battery pack storing electrical energy. The charging trailer also includes a recharging port for receiving electrical power from a charger to recharge the rechargeable battery pack, one or more charging ports for charging one or more batteries associated with electrically powered equipment with the electrical energy stored in the rechargeable battery pack, and a controller for controlling movement of the plurality of wheel assemblies to move the charging trailer to position the charging trailer in a use position to charge the one or more batteries associated with the electrically powered equipment.

Embodiments of the second aspect of the disclosure can include any one or a combination of the following features:
a plurality of sensors for sensing terrain and location of the one or more pieces of electrically powered equipment, wherein the controller generates a control signal to maneuver the vehicle based on sensed signals received from the plurality of sensors;
the plurality of sensors comprises one or more cameras;
the plurality of sensors further comprises one or more radar sensors;
the charge vehicle further comprises one or more robotic arms for connecting one or more charging cables to the one or more charging ports;
the controller controls movement of a canopy or the charging vehicle from a first position to a second position based on sun exposure; and
the charging vehicle is maneuvered about a construction site.

According to a third aspect of the present disclosure, a method of charging electrically powered equipment at a construction site. The method includes the steps of positioning a charging trailer proximate a charging station, maneuvering the charging trailer with a controller via one or more motors to a use position, coupling the charging trailer to one or more batteries associated with the electrically powered equipment, and charging the one or more batteries associated with the electrically powered equipment with the charging trailer.

Embodiments of the third aspect of the disclosure can include any one or a combination of the following features:
sensing terrain and location of the electrically powered equipment, and maneuvering the vehicle with the controller based on sensed signals received from the plurality of sensors;
moving a canopy or the charging vehicle with the controller from a first position to a second position based on sun exposure; and
the charging vehicle is maneuvered about a construction site.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a perspective view of a towing vehicle coupled to a charging vehicle in the form of a charging trailer, according to one example;

FIG. 2 is a top view of the towing vehicle coupled to the charging trailer;

FIG. 3A is a top schematic view of the towing vehicle and the charging trailer positioned relative to a charging station;

FIG. 3B is a schematic top view of the towing vehicle maneuvering the charging trailer towards the charging station;

FIG. 4A is a schematic top view of the charging trailer located at a first position proximate to charging equipment on a construction site, according to one example;

FIG. 4B is a schematic top view of the charging trailer located at a second position proximate to charging equipment at the construction site, according to one example;

FIG. 5 is a block diagram illustrating a controller for controlling the charging trailer, according to one embodiment; and

FIGS. 6A and 6B are a flow chart illustrating a routine for positioning the charging trailer relative to charging equipment at a construction site, according to one example.

### DETAILED DESCRIPTION OF THE PREFERRED EMBODIMENTS

As required, detailed embodiments of the present disclosure are disclosed herein; however, it is to be understood that the disclosed embodiments are merely exemplary of the invention that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present invention.

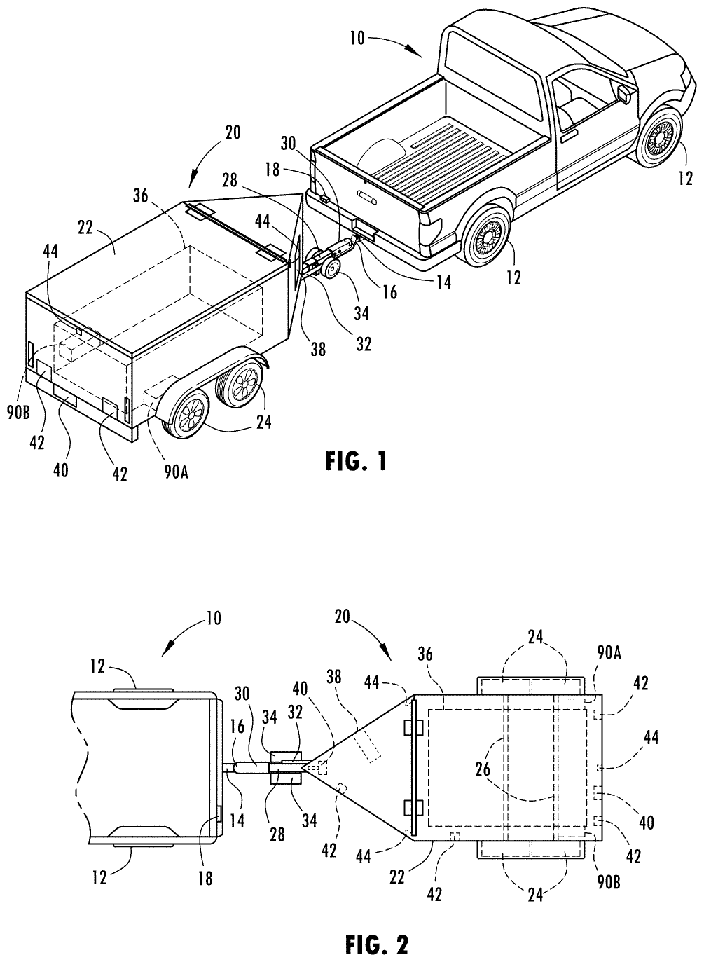

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a charging vehicle, such as a charging trailer, for charging electrically powered equipment. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

Referring to FIGS. 1 and 2, a towing vehicle 10 is generally illustrated towing a mobile charging vehicle, also referred to as a charging trailer 20 according to one example. The tow vehicle 10 may include a motor vehicle, such as an electric vehicle equipped with one or more electric motors and one or more batteries or battery packs for powering the one or more electric motors to accelerate or move the tow vehicle 10. The tow vehicle 10 shown equipped with a plurality of wheel assemblies, such as four wheel assemblies 12. However, it should be appreciated that other types of tow vehicles, such as tow vehicles having track assemblies, may be employed to transport the charging trailer 20. The tow vehicle 10 is further equipped with a tow hitch 14 at the rear end thereof which includes a tow ball 16, in the example shown.

The charging trailer 20 generally includes a trailer body 22 and a plurality of wheel assemblies 24 each having a wheel and tire assembled thereto. The plurality of wheel assemblies 24 in one example are configured with two pairs of wheel assemblies connected to two separate axles 26 that are arranged generally parallel to one another to help balance the charging trailer 20 and support the load contained within the charging trailer 20. The charging trailer 20 may include any number of wheel assemblies or may include other terrain engaging assemblies such as track systems. The charging trailer 20 contains one or more rechargeable battery packs 36 which are configured to be charged to store electrical energy that may be used to charge electrical devices such as the motor vehicle 10 and electrically powered equipment as described herein. Each rechargeable battery pack includes one or more rechargeable batteries such as lithium ion batteries, for example. The stored electrical energy may also be used to directly power one or more devices.

The charging trailer 20 further includes a trailer tongue 28 at the front side thereof which is connected to a trailer coupler 30. The trailer coupler 30 is configured to receive the tow ball 16 on the tow hitch 14 of the tow vehicle 10. It should be appreciated that the charging trailer 20 may be connected to and disconnected from the tow hitch 14 on the tow vehicle 10 via the trailer coupler 30 and tow ball 16.

The trailer tongue 28 further is shown having a jack stand 32 connected thereto which may pivot between a stowed horizontal position and a vertical position serving as a support stand with a jack for supporting the load on the front end of the charging trailer 20 and elevating or lowering the height of the trailer tongue 28 and trailer coupler 30. The jack stand 32 includes one or more wheels, shown as a pair of wheel assemblies 34 such that when the jack stand 32 is in the upright position engage the ground surface to support the front end of the charging trailer 20 and allow the front end of the trailer 20 to move on the ground surface. The wheel assemblies 34 may rotate about a horizontal axis and may pivot about a vertical axis to turn the front end of the trailer in a desired direction.

The charging trailer 20 is further configured with one or more motors shown configured as a pair of electric motors 90A and 90B coupled to one or more wheel assemblies 24 on each of the lateral sides of the charging trailer 20. The motors 90A and 90B may be powered via the electrical energy stored within the battery pack 36. The electric motors 90A and 90B may be energized to propel the trailer 20 in a forward or rearward direction and to turn the trailer left or right by controlling motors 90A and 90B on the opposite lateral sides associated with the wheel assemblies 24. For example, the charging trailer 20 may turn in the left direction or right direction by propelling a wheel assembly 24 on the left or right side in a first direction and may turn in the opposite direction by propelling the wheel assembly 24 in the opposite direction. Wheel assemblies 24 on opposite lateral sides of the charging trailer 20 may be powered in opposite directions to rotate the trailer quickly. As such, the electric motors 90A and 90B are configured to make the charging trailer 20 mobile and drivable when the charging trailer 20 is not connected to a tow vehicle 10.

The charging trailer 20 is further configured to include a plurality of charging ports 42 which are adapted to receive electrical cables from one or more electrically powered devices such that the battery pack 36 may charge the one or more electrical devices which may be oriented in any of a number of positions. The charging trailer 20 further includes one or more robotic arms 40 which may maneuver and position the electrical cables to couple to the charging port 42 to enable the charging of electrical equipment and to disconnect the electrical cables from the charging port 42. The robotic arms 40 may be controlled based on the use of sensors, such as an imaging radar and camera sensors 44 located at various locations on the charging trailer 20. The imaging radar and camera sensors 44 are shown located on left and right sides of the charging trailer 20 angled forward and on a rear side of the charging trailer 20. The radar and camera sensors 44 may include a plurality of radar sensors and a plurality of cameras and may have a wide angle sensing region and may cover a substantial or entire region surrounding the charging trailer 20. It should be appreciated that the imaging radar and camera sensors 44 may sense the position of electric powered equipment to be charged and may control one or more robotic arms to connect a cable to the charging trailer 20 to enable the electrical device to be charged via the battery pack 36.

In addition, it should be appreciated that the tow vehicle 10 may include a vehicle charging port 18 to enable a cable to be connected to the battery pack 36 on the charging trailer 20 such that one or more battery packs on the tow vehicle 10 may be electrically charged by the battery pack 36 to thereby extend the driving range of the tow vehicle 10.

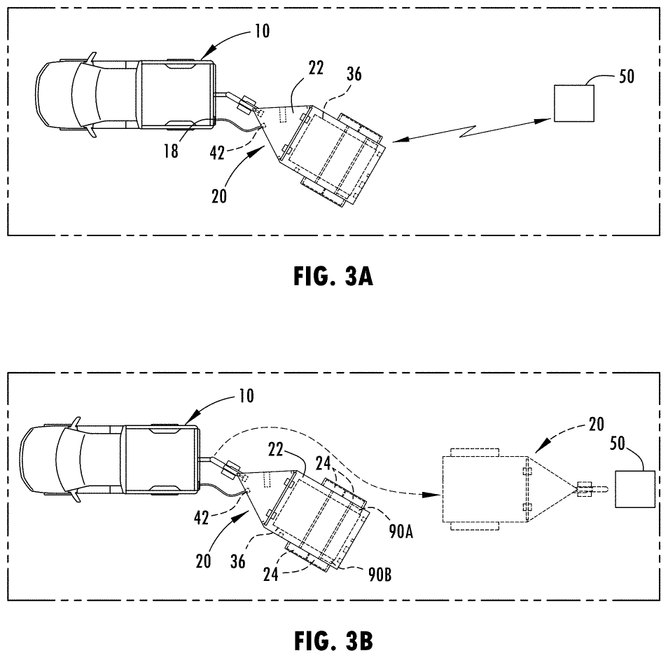

Referring to FIGS. 3A and 3B, the tow vehicle 10 is generally shown positioning the charging trailer 20 in proximity to and within an operating range of a charging station 50. The charging station 50 may include a fixed wall charger or a standalone substation charger that receives electrical power from a remote power source, such as an electrical supply grid. The charging station 50 may receive alternating current (AC) electrical power at a certain voltage, such as 115 volts or 240 volts, for example, and may convert the AC power to direct current (DC) power and may supply the charging trailer 20 with either AC or DC power at a desired voltage to charge the battery pack 36 in the charging trailer 20. It should be appreciated that the charging station 50 may be electrically connected to the charging trailer 20 via an electrical cable on a powered cable reel 38. As such, the charging trailer 20 when connected to a charging station 50 may enable the rechargeable battery pack 36 to be charged.

As seen in FIG. 3B, the tow vehicle 10 may be disconnected and removed from the charging trailer 20 and the charging trailer 20 may be powered and steered via the electric motors 90A and 90B to move to a desired position shown proximate to the charging station 50 within range of connecting to the charging station 50. It should be appreciated that the charging trailer 20 may be powered to move to any of a number of other positions within a given site, such as on a construction site, and may be oriented in any of a number of orientations to accommodate charging and recharging operations. For example, the charging trailer 20 may move about a construction site to enable the charging trailer 20 to be connected to the charging station 50 and to position the charging trailer 20 to enable the charging trailer 20 to be easily connected to one or more pieces of electrical equipment located at the construction site.

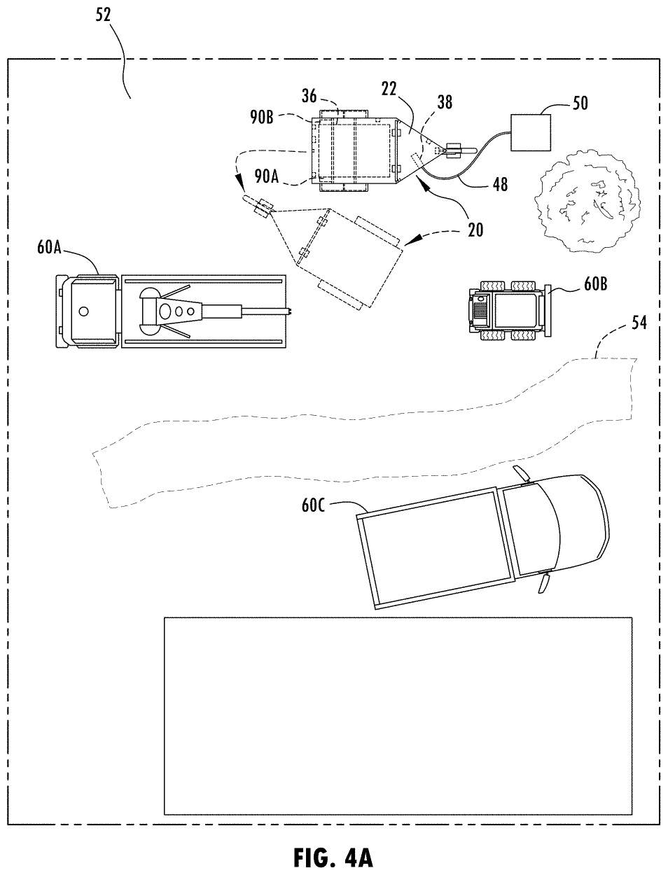

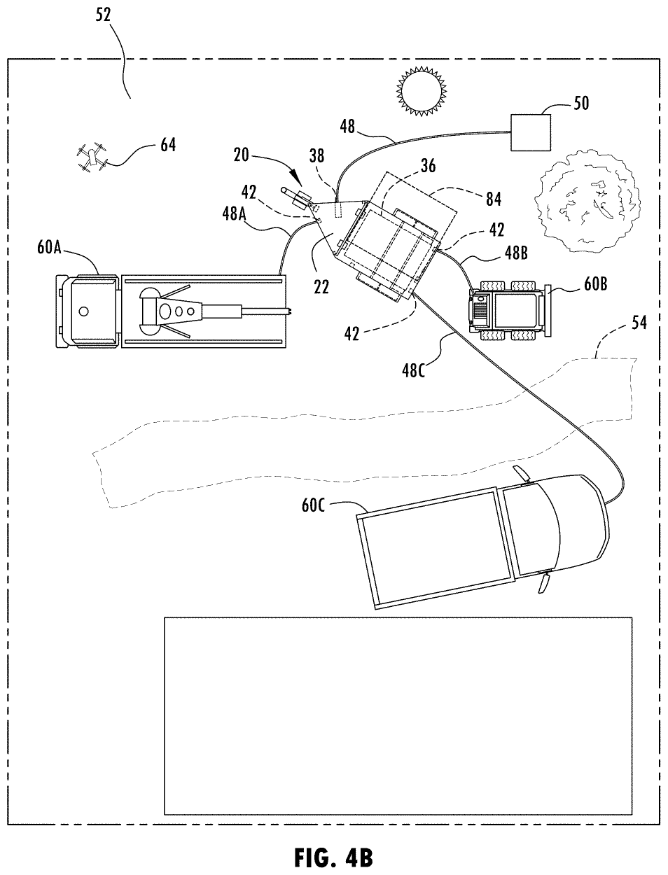

Referring to FIGS. 4A and 4B, the charging trailer 20 is shown electrically connected via cable 48 to the charging station 50 at a construction site 52. It should be appreciated that the construction site 52 may include varying terrain, which is common such as a rough surface area 54 and other terrain upon which a plurality of vehicles, such as electrically powered vehicles and equipment may maneuver and be located. The charging trailer 20 may maneuver to various locations within the construction site 52 to accommodate the electric charging of one or more rechargeable batteries located on equipment such as, for example, an electric powered crane 60A, an electric powered skid loader 60B and another electrical powered vehicle 60C. Each of the electrically powered equipment 60A-60C may communicate with the charging trailer 20 via wireless communication, such as via transceivers, and the electrically powered equipment 60A-60C and/or the charging trailer 20 may maneuver around the construction site 52 to enable the electrically powered equipment 60A-60C to be connected to the charging trailer 20 to charge rechargeable batteries in the electrically powered equipment 60A-60C as needed. For example, the charging trailer 20 may move about the terrain to various locations on the construction site 52 to enable connection to one or more pieces of the electrically powered equipment to charge the electrically powered equipment as needed. This may include maneuvering the charging trailer 20 while the charging trailer 20 remains connected to the charging station 50 or to disconnect the charging trailer 20 from the charging station 50 and to move to a remote location away from the charging station 50 to charge the electrically powered equipment 60A-60C. Likewise, the electrically powered equipment 60A-60C may maneuver on the terrain about the construction site 52 to move into closer proximity to the charging trailer 20 to enable the charging trailer 20 to be connected thereto. This may include maneuvering the charging trailer 20 into a better location and orientation that enables connection to one or more of the electrically powered devices to more efficiently allow for recharging of the batteries employed in the electrically powered equipment 60A-60C.

It should be appreciated that the charging trailer 20 and the electrically powered equipment 60A-60C may utilize positioning data, such as global positioning data, mapping data, and location data gathered from other sources, such as a drone, sensors such as cameras, radar, etc., and may maneuver about the construction site 52 based on the mapping data.

The charging trailer 20 may be equipped with a canopy 84 or other cover and may include a sunlight detector to detect the presence of sunlight exposed to the charging trailer 20 as shown in FIG. 4B. When this occurs, the charging trailer 20 may activate a motor or other actuator to move the canopy 84 into a position to cover the charging trailer 20 from the sunlight so as to reduce or minimize the amount of sunlight that is exposed to the charging trailer 20 to reduce heat that may otherwise build up on the battery pack 36 in the charging trailer 20. Further, the charging trailer 20 may maneuver about different positions to enable the canopy 84 to better cover the charging trailer 20 and the battery pack 36.

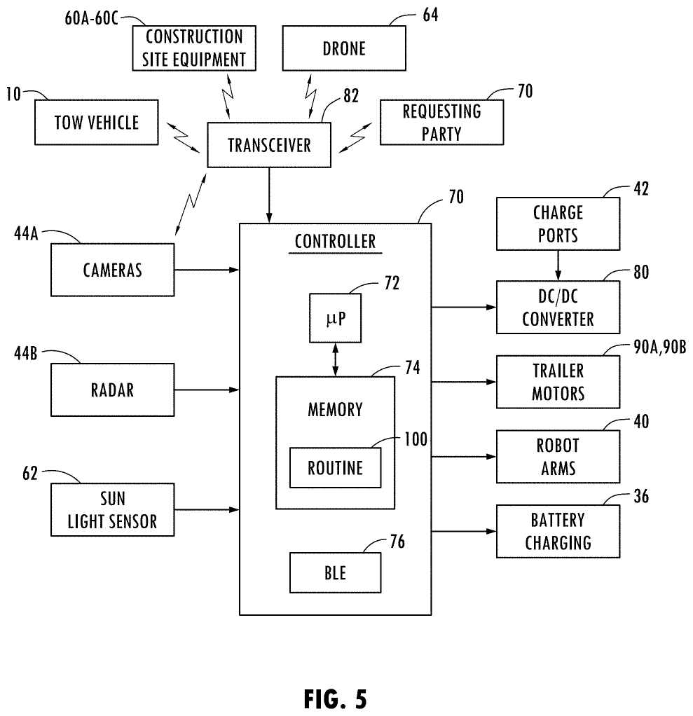

Referring to FIG. 5, a controller 70 is shown for controlling maneuverability and operation of the charging trailer 20 and the electrical charging and communication with various mobile vehicles and devices. The controller 70 may include a microprocessor 72 and memory 74, according to one example. It should be appreciated that the controller 70 may include any analog and/or digital control circuitry. In the example shown, the memory 74 includes a routine 100 which may be executed by the microprocessor as described herein. The controller 70 may further include a wireless enabled device such as a Bluetooth® low energy device, to enable communication with other Bluetooth® or other wireless devices in close proximity to the charging trailer 20.

The controller 70 receives various inputs, processes the inputs and routine 100, and generates various outputs. The controller 70 receives signals from sensors including cameras 44A and radar 44B. In addition, the controller 70 receives a light sensing signal from the sunlight sensor 62. The controller 70 further communicates with a transceiver 82 which, in turn, may communicate with various other devices. For example, the transceiver 82 may communicate with one or more requesting parties such as electrically powered equipment that may be electrically charged with the charging trailer. In addition, the transceiver 82 may communicate with a drone 64 and the electrically powered equipment 60A-60C on the construction site. The transceiver 82 may further communicate with the tow vehicle 10 and the charging station.

The controller 70 processes the routine 100 based on the various inputs and may control any of a number of output devices. For example, the controller 70 may communicate with a DC/DC converter 80 which may convert DC power from a first voltage level to a second voltage level. For example, DC voltage of 240 volts may be converted to a voltage of 400 volts or 800 voltage which may then be utilized to charge electrical powered equipment via the charging ports 42. The controller 70 further generates an output signal to control the electric motors 90A and 90B on the charging trailer so as to maneuver the charging trailer in forward and rearward directions and to turn the charging trailer left and right, to thereby maneuver the charging trailer to various locations at the construction site. The controller 70 may further control one or more of the robotic arms 40 so as to connect or disconnect one or more cables to enable electrical charging of electrically powered equipment with the battery pack on the charging trailer. Further, the controller 70 may communicate with the battery charging to control the charging process for charging electrically powered equipment with the battery pack and to control the recharging of the pack of batteries with the charging station. The controller 70 may further include wireless communication circuitry shown as Bluetooth® low energy (BLE) circuitry 76 to enable direct wireless communication with one or more devices.

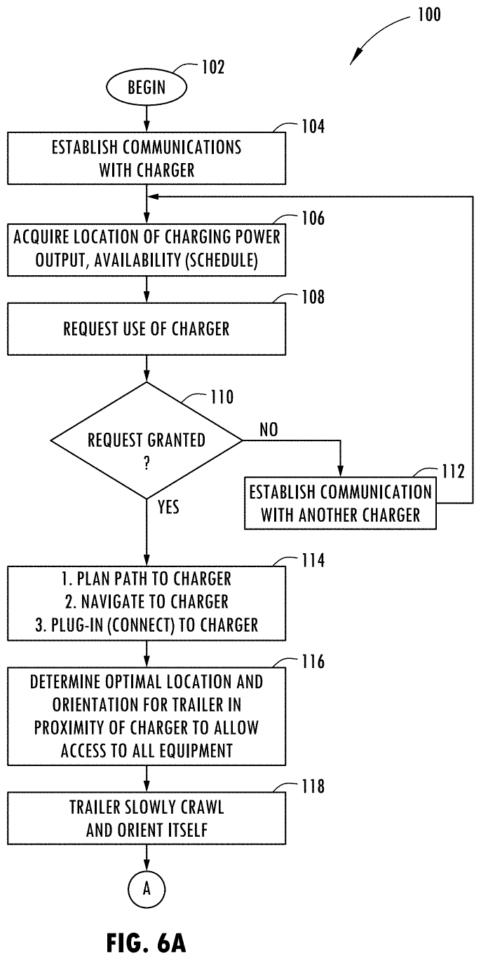

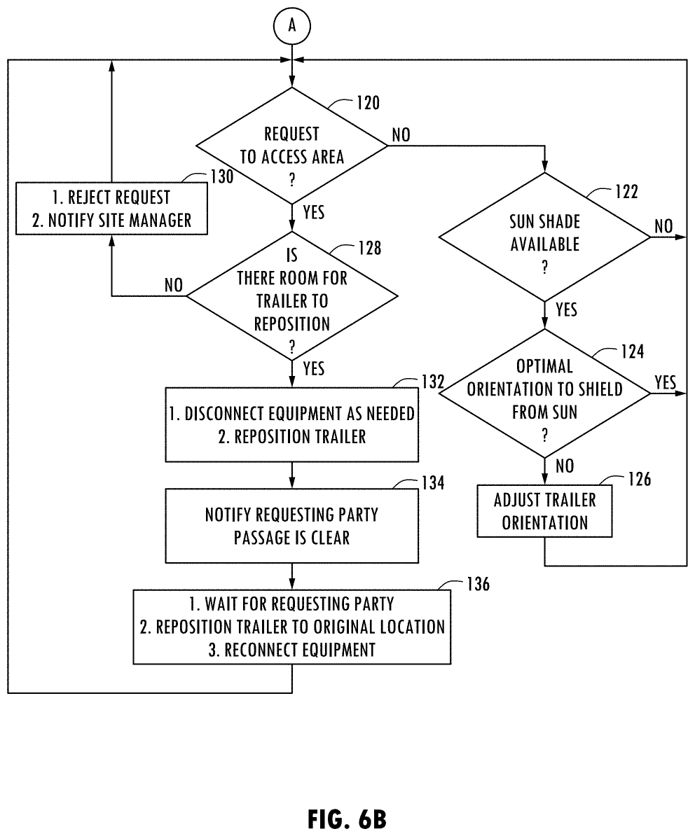

Referring to FIGS. 6A and 6B, the routine 100 is further illustrated according to one exemplary embodiment. Routine 100 begins at step 102 and proceeds to step 104 to establish communications between the charging trailer and with the charger, also referred to as the charging station. Next, at step 106, routine 100 acquires the location of the charging power output and availability, such as when it may be available on a given schedule. Routine 100 then proceeds to step 108 to request use of the charging station. At decision step 110, routine 100 determines if the request is granted and, if not, proceeds to step 112 to establish communication with another charging station before returning to step 106. If the request is granted, routine 100 proceeds to step 114 to plan a travel path for the charging trailer to reach or be proximate to the charging station and to navigate the path to the charging station and to plug-in or connect the charging trailer to the charging station. Thereafter, at step 116, routine 100 will determine the optimal location and orientation for the charging trailer in proximity of the charging station to allow access to rechargeable equipment. Next, at step 118, routine 100 will cause the charging trailer to move at a slow speed, such as to crawl, and orient itself by using the electric motors on the charging trailer. In doing so, routine 100 may proceeds to decision step 120 to request access to an area. If access is not granted, routine 100 proceeds to step 122 to determine if a sunshade is available and, if not, returns, to step 120. If a sunshade is available, routine 100 proceeds to decision step 124 to determine if the current position is in the optimal orientation to shield the charging trailer from the sunlight is available and, if so, returns to step 120. If the optimal orientation to shield from the sunlight is not realized, routine 100 proceeds to step 126 to adjust the trailer orientation in an attempt to better shield the charging trailer from sunlight, before returning to step 120.

If the request to access an area is granted, routine 100 proceeds to decision step 128 to determine if there is room for the charging trailer to be repositioned and, if not, proceeds to step 130 to reject the request and to notify the site manager before returning to step 120. If there is room for the charging trailer to be repositioned, routine 100 proceeds to step 132 to disconnect the rechargeable equipment as needed and to reposition the charging trailer by using the electric motors. Next, at step 134 routine 100 will notify the requesting party that the passage is clear before proceeding to step 136 to wait for a requesting party, to reposition the charging trailer to the original location and to reconnect the equipment, before returning to step 120.

Accordingly, it should be appreciated that a charging vehicle, such as the charging trailer 20, advantageously provides for a mobile vehicle that enables the charging of rechargeable electrical powered equipment and recharging with a charging station. The charging trailer may move amongst a plurality of positions and to various orientations to charge the electrically powered equipment, which is particularly well-suited for use at a construction site.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A charging vehicle comprising:
one or more motors to maneuver the charging vehicle;
a rechargeable battery pack for storing electrical energy;
a recharging port for receiving electrical power from a charger to recharge the rechargeable battery pack;
one or more charging ports for charging one or more batteries associated with electrically powered equipment with the electrical energy stored in the rechargeable battery pack; and
a controller for controlling movement of the charging vehicle to position the charging vehicle in a use position to charge the one or more batteries associated with the electrically powered equipment.

2. The charging vehicle of claim 1, wherein the charging vehicle is configured as a charging trailer.

3. The charging vehicle of claim 1 further comprising a plurality of sensors for sensing terrain and location of the electrically powered equipment, wherein the controller generates a control signal to maneuver the vehicle based on outputs received from the plurality of sensors.

4. The charging vehicle of claim 3, wherein the plurality of sensors comprises one or more cameras.

5. The charging vehicle of claim 4, wherein the plurality of sensors further comprises one or more radar sensors.

6. The charging vehicle of claim 1, wherein the charge vehicle further comprises one or more robot arms for connecting one or more charging cables to the one or more charging ports.

7. The charging vehicle of claim 1, wherein the controller controls movement of a canopy or the charging vehicle from a first position to a second position based on sun exposure.

8. The charging vehicle of claim 1 further comprising a plurality of wheels.

9. The charging vehicle of claim 1, wherein the charging vehicle is maneuvered about a construction site.

10. A charging trailer comprising:
a plurality of wheel assemblies;
one or more motors operatively coupled to the plurality of wheel assemblies to maneuver the charging trailer;
a rechargeable battery pack storing electrical energy;
a recharging port for receiving electrical power from a charger to recharge the rechargeable battery pack;
one or more charging ports for charging one or more batteries associated with electrically powered equipment with the electrical energy stored in the rechargeable battery pack; and
a controller for controlling movement of the plurality of wheel assemblies to move the charging trailer to position the charging trailer in a use position to charge the one or more batteries associated with the electrically powered equipment.

11. The charging trailer of claim 10 further comprising a plurality of sensors for sensing terrain and location of the one or more pieces of electrically powered equipment, wherein the controller generates a control signal to maneuver the vehicle based on sensed signals received from the plurality of sensors.

12. The charging trailer of claim 11, wherein the plurality of sensors comprises one or more cameras.

13. The charging trailer of claim 12, wherein the plurality of sensors further comprises one or more radar sensors.

14. The charging trailer of claim 10, wherein the charge vehicle further comprises one or more robotic arms for connecting one or more charging cables to the one or more charging ports.

15. The charging trailer of claim 10, wherein the controller controls movement of a canopy or the charging vehicle from a first position to a second position based on sun exposure.

16. The charging trailer of claim 10, wherein the charging vehicle is maneuvered about a construction site.

17. A method of charging electrically powered equipment at a construction site, the method comprising:
positioning a charging trailer proximate a charging station;
maneuvering the charging trailer with a controller via one or more motors to a use position;
coupling the charging trailer to one or more batteries associated with the electrically powered equipment; and
charging the one or more batteries associated with the electrically powered equipment with the charging trailer.

18. The method of claim 17 further comprising:
sensing terrain and location of the electrically powered equipment; and
maneuvering the vehicle with the controller based on sensed signals received from the plurality of sensors.

19. The method of claim 17 further comprising moving a canopy or the charging vehicle with the controller from a first position to a second position based on sun exposure.

20. The method of claim 17, wherein the charging vehicle is maneuvered about a construction site.
